(19) United States
(12) Patent Application Publication
(10) Pub. No.: US 2011/0221701 A1
(43) Pub. Date: Sep. 15, 2011

(54) Multi-touch detection method for capacitive touch screens

(75) Inventors: Jingkai Zhang, Shenzhen (CN); Yan Guo, Shenzhen (CN); Lianghua Mo, Shenzhen (CN)

(73) Assignee: Focaltech Systems Ltd.

(21) Appl. No.: 13/065,024

(22) Filed: Mar. 10, 2011

(30) Foreign Application Priority Data
Mar. 10, 2010 (CN) 20101021635.9

(51) Int. Cl. G06F 3/045

(52) U.S. Cl. 345/174

(57) ABSTRACT

This invention discloses a multi-touch detection method for capacitive touch screens, which includes the following steps: conducting scan detection of capacitance of the rows and columns of a touch screen matrix to respectively acquire the capacitance data of the rows and columns of the touch screen matrix; acquiring an initial capacitance threshold value and calculating capacitance value of each row and each column by subtracting the initial capacitance threshold value from the capacitance data of each row and each column respectively; judging whether a curved section with a capacitance value of more than zero exists in the calculated capacitance value curve of the rows and columns; if so, the gravity center point of each curved section with a calculated capacitance value of more than zero is taken as the contact point coordinate corresponding to the curved section; if not, no touch is made; and the column coordinate and the row coordinate of each contact point is sent to a processor for processing. This invention reduces the volume of data with processing necessity, decreases the load of the processor, improves the anti-interference performance of a system to a certain extent, and also lowers the probability of wrong touch.

### BACKGROUND OF THE PRESENT INVENTION

1. Field of Invention This invention relates to a touch screen technology, in particular to a multi-touch detection method for capacitive touch screens.

2. Description of Related Arts

A touch screen can have several implementation principles and popular touch screens include resistive touch screens, capacitive touch screens and surface infrared touch screens. The resistive touch screens have been popular for many years due to the advantages of low cost, easy implementation and simple control. Recently, the capacitive touch screens have been welcomed by the general public due to the advantages of high light transmittance, abrasion resistance, resistance to environmental changes (temperature, humidity, etc.), long service life and implementation of advanced complicated functions, such as multi touch.

As shown in FIG. 1, a self-capacitive touch screen is composed of two ITO layers, one is connected to the earth, and the other is connected with a scanning line. Take a single point as an example, 10 is the scanning line. When no finger 30 touches, the equivalent capacitance on 10 is the capacitance 20 of two coupled ITO layers of, namely Cx; when a finger touches, as the finger has an equivalent earth capacitance 40, namely Cf, the equivalent capacitance corresponding to the scanning line 10 is Cx+Cf. Whether this point is touched can be judged through distinguishing the capacitance before and after touching. When many points constitute a matrix array, an equivalent circuit as shown in FIG. 2 is formed.

The U.S. Pat. No. 5,825,352 discloses a multi-touch detection method. Such a detection method adopts the time division multiple access (TDMA) technology, which detects touches by employing the peak value detection method and valley value detection method respectively for the X axis and Y axis of a touch screen. In other words, one row or one column is scanned each time, for instance, the touch coordinate of Y is acquired by firstly scanning the Y direction and then the X coordinate is acquired by scanning the X direction. When two fingers (solid-line concentric circles in FIG. 3) 320 touch the surface of the touch screen, the distribution of capacitance on the X axis and the Y axis will present a wave shape as shown in FIG. 3.

In FIG. 3, due to the touch of the finger, a wave peak will emerge in the Y direction, as shown by 310, and two wave peaks 340 and 350 as well as a wave valley 360 will emerge in the X direction, as shown by 330. During detection of the touch coordinate, the U.S. Pat. No. 5,825,352 firstly detects the first wave peak 340, then detects the wave valley 360 beside such a wave peak, and finally detects the wave peak 350 behind such a wave valley, and the like. If an obvious wave valley exists, it means that two capacitance points are touched. Similarly, if two obvious wave valleys exist, it means that three capacitance points are touched.

With the adoption of this detection method, the capacitance peak value and capacitance valley value are detected successively according to the coordinate direction and then the coordinates of the touches are distinguished by employing the method of combining the peak value and valley value; in this way, the data of entire screen is required to be processed, thus increasing the burden of the processor.

### SUMMARY OF THE PRESENT INVENTION

The technical problem to be solved by this invention is to provide a multi-touch detection method for capacitive touch screens, with the adoption of which less data are required to be processed and the burden of the processor is able to be reduced.

For the purpose of solving such a technical problem, the technical proposal adopted by this invention is a multi-touch detection method for capacitive touch screens, which includes the following steps:

101) conducting scan detection of capacitance of the rows and columns of a touch screen matrix to respectively acquire capacitance data of the rows and columns of the touch screen matrix;

102) acquiring an initial capacitance threshold value and calculating capacitance value of each row and each column by subtracting the initial capacitance threshold value from the capacitance data of each row and each column respectively;

103) judging whether a curved section with a capacitance value of more than zero exists in the calculated capacitance value curve of the rows and columns; if so, the gravity center point of each curved section with a calculated capacitance value of more than zero is taken as the contact point coordinate corresponding to such curved section; if not, no touch is made;

104) The column coordinate and the row coordinate of each contact point is sent to a processor for processing.

The above-mentioned multi-touch detection method for capacitive touch screens is characterized in that each row and each column of the touch screen matrix have a respective initial capacitance threshold value.

The above-mentioned multi-touch detection method for the capacitive touch screen is characterized in that the capacitance threshold value of each row of the touch screen matrix is the sum of the scanning capacitance value of such row and the increment of row capacitance value, and the capacitance threshold value of each column is the sum of the scanning capacitance value of such column and the increment of column capacitance value, in which the scanning capacitance value is the capacitance value to the extent that no touch is imposed on the rows or the columns of the touch screen matrix.

The above-mentioned multi-touch detection method for the capacitive touch screen is characterized in that under the circumstance of having no touch, the capacitance threshold value is updated once the touch screen matrix scans a cycle.

The above-mentioned multi-touch detection method for the capacitive touch screen is characterized in that, in Step 103, after the existence of the curved section with a capacitance value of more than zero in the calculated capacitance value curve of the rows and columns is judged, the highest point of each curved section with a capacitance value of more than zero is firstly sought through gradual increase of the capacitance threshold value, capacitance value curved sections on both sides of the highest point are retained according to a default width value, and then the gravity center point of each calculated capacitance value curved section is taken as the contact point coordinate corresponding to the curved section.

The above-mentioned multi-touch detection method for capacitive touch screens is characterized in that when the row coordinate and the column coordinate of two neighboring contact points are smaller than the default coordinate threshold value, the coordinates of such two neighboring contact points are combined into the coordinates of the touch points as per the arithmetic mean.

The above-mentioned multi-touch detection method for the capacitive touch screen is characterized in that under the circumstance of having only one touch point, the movement of such touch point on a screen is judged to be the trail of an image.

The above-mentioned multi-touch detection method for the capacitive touch screen is characterized in that when the straight-line distance between two given touch points changes, it is judged to zoom an image; and when one given touch point revolves around the other given touch point, it is judged to rotate an image.

The above-mentioned multi-touch detection method for the capacitive touch screen is characterized in that, in case that two given touch points revolve relatively while the straight-line distance between such two given touch points changes, if the angle of rotation is smaller than the default value, it is judged to zoom an image; if the angle of rotation is larger than the default value, it is judged to rotate an image.

The above-mentioned multi-touch detection method for the capacitive touch screen is characterized in that, in case that one of the two given touch points does not move and the other point moves, if the moving direction of the moving touch point forms an included angle smaller than the default angle with the connecting line between such two given touch points, it is judged to zoom an image; if the moving direction of the moving touch point forms an included angle larger than the default angle with the connecting line between such two given touch points, it is judged to rotate an image.

With regard to the multi-touch detection method for capacitive touch screens, as a detection capacitance is provided with a threshold value, the processor is only required to process capacitance data with a value of higher than such a threshold value, thus reducing the volume of data with processing necessity, decreasing the load of the processor, improving the anti-interference performance of a system to a certain extent, and also lowering the probability of wrong touch.

### BRIEF DESCRIPTION OF THE DRAWINGS

FIG. 1 is the schematic diagram of touch detection for touch screens based on the prior art.

FIG. 2 is the equivalent circuit diagram of a self-capacitive touch screen based on the prior art.

FIG. 3 is the distribution diagram of touch capacitance based on the prior art.

FIG. 4 is the comparison diagram of touch detection methods based on this invention and the prior art, in which FIG. 4.1 is the schematic diagram of “sea level” and FIG. 4.2 is the schematic diagram of coordinate calculation.

FIG. 5 is the flow chart of multi-touch detection method for capacitive touch screens in this invention, in which FIG. 5.1 is the flow chart of touch coordinate calculation and FIG. 5.2 is the flow chart of “peak” separation.

FIG. 6 is the schematic diagram of the movement of the embodiment image of the multi-touch detection method for the capacitive touch screens in this invention, in which FIG. 6a is the schematic diagram of finger touch action for image movement and FIG. 6b is the schematic diagram of image movement.

FIG. 7 is the schematic diagram of the zooming of the embodiment image of the multi-touch detection method for capacitive touch screens in this invention, in which FIG. 7a is the schematic diagram of finger touch action for image zooming and FIG. 7b is the schematic diagram of image zooming.

FIG. 8 is the schematic diagram of the rotation of the embodiment image of the multi-touch detection method for capacitive touch screens in this invention, in which FIG. 8a is the schematic diagram of finger touch action for image rotation and FIG. 8b is the schematic diagram of image rotation.

FIG. 9 is the schematic diagram of self-capacitance multi-touch “ghost” mechanism.

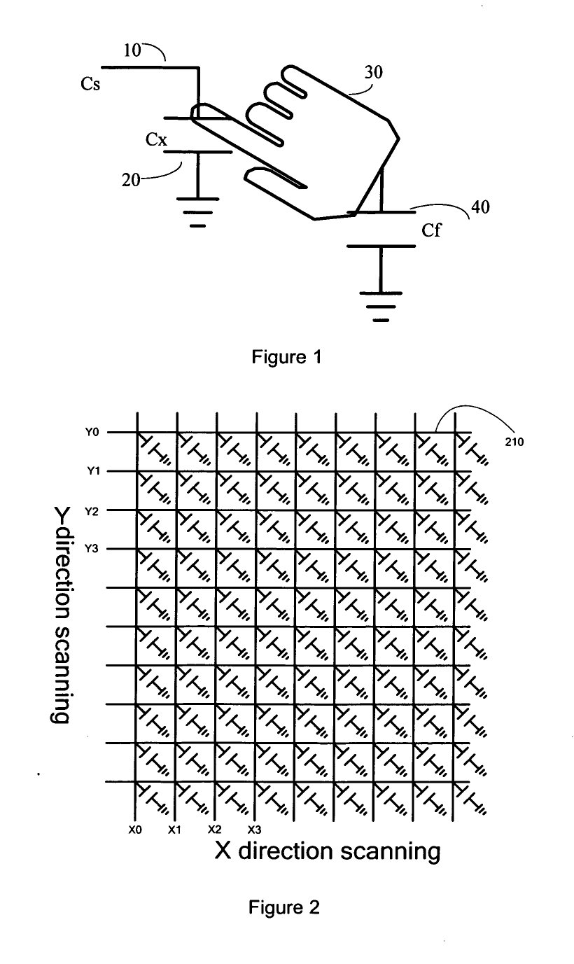

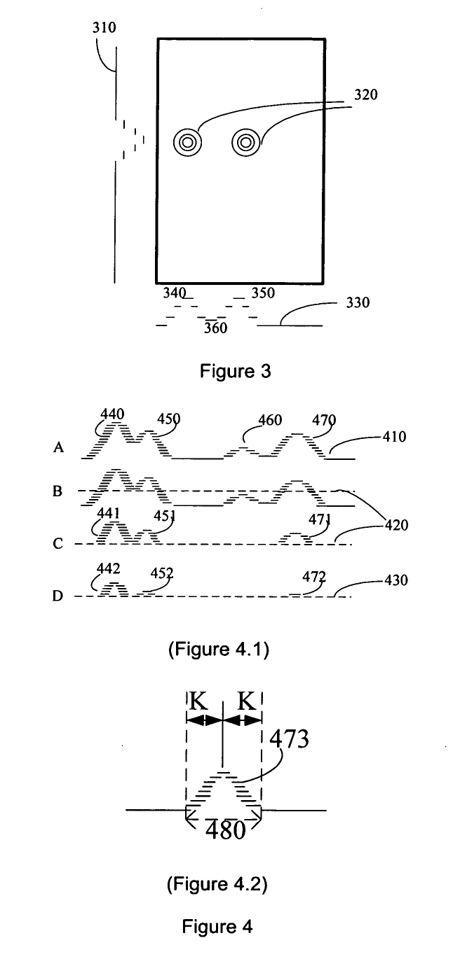

### DETAILED DESCRIPTION OF THE PREFERRED EMBODIMENT

In FIG. 4.1, 410 shown in Figure A is the original sampling data and each touch row or column contains many “peaks” constituted by capacitances of different values. In respect of U.S. Pat. No. 5,825,352, 410 is directly processed to acquire the peak value and valley value corresponding to each of “peaks” 440, 450, 460 and 470. In FIG. B, 420 is the initial “sea level” constituted by row and column capacitance threshold values in this invention. Such a “seal level” can be temperatures, humidities and functions constituting matrix capacitance rows and columns. If the “sea level” constituted by row and column capacitance threshold values is higher, the capacity of resisting disturbance increases the sensitivity decreases; if the “sea level” is lower, the capacity of resisting disturbance reduces and the sensitivity increases. In Figure C, after the processing by the “sea level” 420 constituted by row and column capacitance threshold values, “peaks” constituted by curved sections higher than the “sea level” and with a capacitance value of more than zero are acquired as shown by 441, 451 and 471. If no “peak” exists in FIG. C, it means that no touch occurs.

It can be seen from FIG. 4.1 C that “peaks” formed by touch points are separated by the “sea level”. Flat “planes” are on both sides of the “peak” of each curved section with a capacitance value of more than zero. In this way, the coordinate of the touch point can be conveniently determined according to the following Formula 1) for determining the coordinate of the gravity center point. For the purpose of being more accurate, the following steps can also be followed:

In FIG. D, 430 is a new “sea level” rising again from the “sea level” 420, and the rising height of the “sea level” is better when an acnode 472 appears.

In FIG. 4.2, 2K+1 data (K predefined as a natural number, such as 1, 2, 3 . . . ) are selected from 471 in FIG. 4.1 C with 472 in FIG. 4.1D as the central point based on bilateral symmetry to acquire the separated “peak” 473. Then the coordinate of area 473 is determined according to the following Formula 1) for determining the coordinate of the gravity center point. In this way, results to be processed greatly reduce and the capacity of resisting disturbance of the system increases (for instance, the capacitance “peak” 460 generated due to disturbance in FIG. 4.1A is removed).

$$Formula 1 ) for determining coordinates of gravity center point \text{:} \\ \{ \begin{matrix}{X}_{M} = \frac{{\sum }_{i} ( {x}_{i} * Δ {C}_{i} )}{{\sum }_{i} Δ {C}_{i}} \\ {Y}_{M} = \frac{{\sum }_{i} ( {y}_{i} * Δ {C}_{i} )}{{\sum }_{i} Δ {C}_{i}}\end{matrix} \qquad$$

If, after the formation of the acnode 472, capacitance “peaks” such as 442 and 452 still exist over the “sea level” 430, the height of the “sea level” can be increased continuously until the next capacitance value acnode appears; otherwise, all capacitance “peaks” are deemed to be separated.

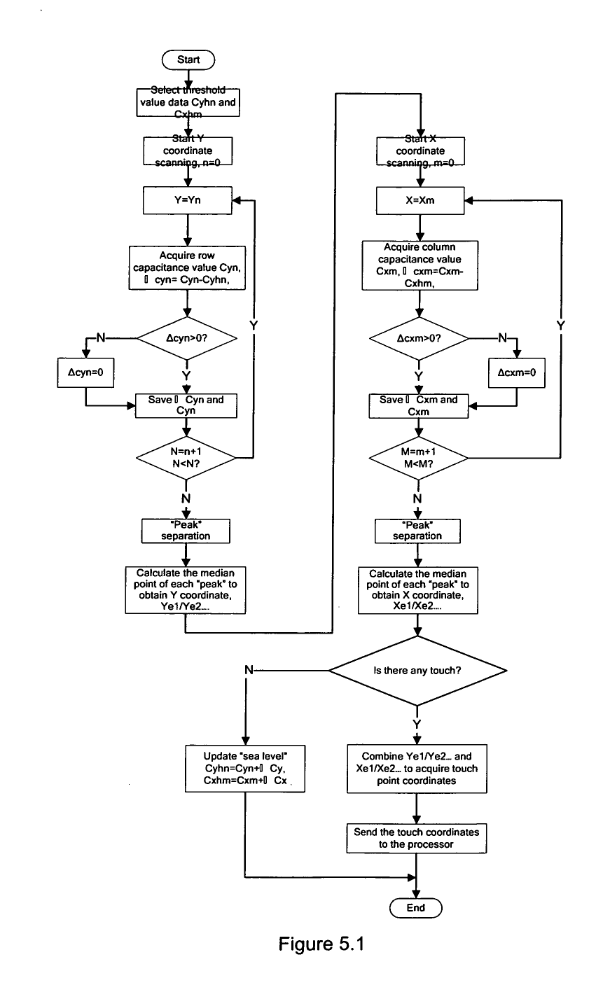

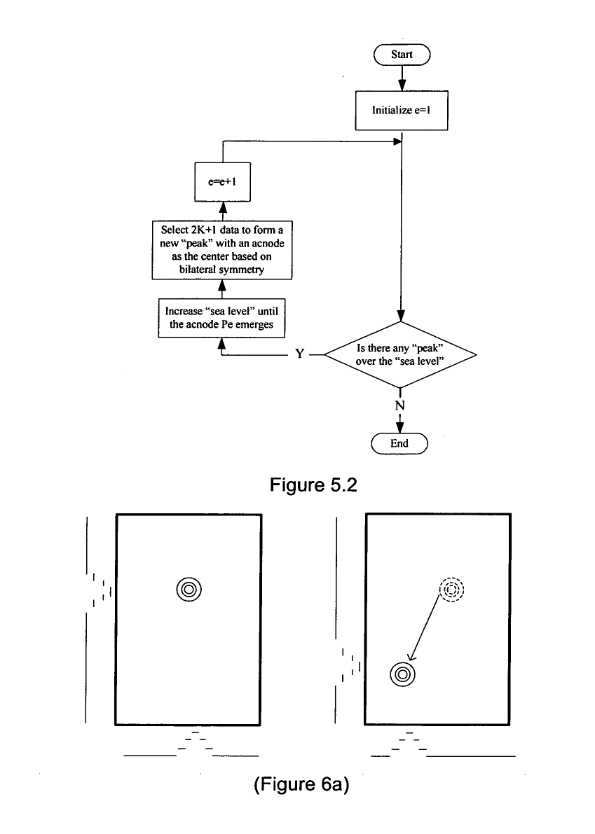

As mentioned above, the “sea level” constituted by row and column capacitance threshold values is related to temperature, humidity and row and column capacitance constituting the matrix. For the purpose of avoiding “false response” or “no response”, such a “sea level” is required to be adjusted in real time. Refer to the self-adjustment technology in FIG. 5, i.e. after each frame scanning is finished, whether a touch exists is judged; if none, the capacitance threshold value is updated according to the scanning results. In other words, under the circumstance of having no touch, when the touch screen matrix is scanned for each cycle, the capacitance threshold value is updated once, which not only reflects the impact of unevenness factor of the touch screen matrix constitution on the matrix row and column capacitance but also reflects the impact of changes in temperature and humidity on the matrix row and column capacitance to the capacitance threshold value. In this way, the “sea level” constituted by row and column capacitance threshold values is not a real “plane”. Due to the difference of production processes, each row or column of the corresponding matrix of the touch screen has one capacitance threshold value. All such capacitance threshold values constitute an initial “sea level” with slight fluctuation.

FIG. 5.1 is the flow chart of the multi-touch detection method for capacitive touch screens in this invention. After the scanning procedure is started, the capacitance threshold value data of each column Cyhn (n is one of 0 to N−1, in which N is the number of rows of the capacitive touch screen) and the capacitance threshold value data of each row Cxhm (m is one of 0 to M−1, in which M is the number of columns of the capacitive touch screen) are firstly selected.

After the capacitance threshold value data are selected, row and column scanning is conducted. Firstly, rows are scanned, from row 1 to row N. The capacitance threshold value of the corresponding row Cyhn subtracted from each scanned capacitance data Cyn is ΔCyn, which is the capacitance value of row n above the threshold value. ΔCyn and Cyn are stored. The processing of ΔCyn is subject to the following law: if this difference value ΔCyn is equal to or less than zero, ΔCyn saved is 0; otherwise, the capacitance value ΔCyn above ( ) the threshold value (capacitance threshold value) is stored.

After scanning is finished, “peak” separation can be conducted. 473 in FIG. 4.2 and FIG. 5.2 can be referred to for the separation method. When row scan is finished, whether a “peak” exists above the initial “sea level” is firstly judged; if so, the “sea level” is ascended until the first capacitance acnode appears, for example, 472 appears in FIG. 4.1D. With 471 in FIG. 4.1 C as the center, 2K+1 data is selected from 471 to form new “peaks”. Then whether “peaks” exist above the new “sea level” is judged; if so, the “sea level” is ascended continuously to acquire the second capacitance acnode to form a second “peak”. The “sea level” is ascended continuously until the capacitance acnodes of all “peaks” are selected and new separated “peaks” are formed. When no isolated capacitance exists above the “sea level”, it means that separation is finished.

After “peak” separation is finished, each separated “peak” can be calculated according to Formula 1) to determine the gravity center point of each “peak”, that is, the center row coordinate of each “peak”.

According to the foregoing method, the center column coordinate of each peak can also be determined.

When the row and column coordinates of each peak is determined, coordinates can be combined to determine the coordinate of the touch point. In order to avoid the appearance of several capacitance acnodes at one touch peak, a coordinate value (such as 5 mm) can be set. When the row and column coordinates of two neighboring touch points are less than such a threshold value, a new coordinate can be obtained based on the arithmetic mean of such two coordinates, which is the coordinate of the touch point.

According to the above analysis, such a detection method has nothing to do with the number of touch points.

After a capacitance frame is scanned, whether a touch exists is firstly judged, i.e. whether a row or a column has any “peak”; if so, the touch coordinate is sent to the processor in order to finish the corresponding action; if none, both ΔCyn and ΔCxm are zero, all capacitance threshold values are updated. The processing method is as follows: when the stored Cyn and Cxm are selected, new capacitance threshold values are Cyhn=Cyn+ΔCy, Cxhm=Cxm+ΔCx, in which the capacitance value increments ΔCy and ΔCx are fixed constants; if the sensitivity is required to be higher, the capacitance value increments ΔCy and ΔCx can be reduced to a certain extent; if the capacity of resisting disturbance is required to be stronger, the capacitance value increments ΔCy and ΔCx can be increased to a certain extent.

Parameters in FIG. 5 are defined as follows:

| Name | Definition |
|---|---|
| N | Number of rows |
| M | Number of columns |
| Cyn | Scanned capacitance value of row n |
| ΔCyn | Capacitance value visible in row n above the threshold value |
| Cyhn | Capacitance threshold value corresponding to row n |
| Cxm | Scanned capacitance value of column m |
| ΔCxm | Capacitance value visible in column m |
| | above the threshold value |
| Cxhm | Capacitance threshold value corresponding to column m |
| ΔCy | Row capacitance value increment constituting the initial |
| | capacitance “sea level” |
| ΔCx | Column capacitance value increment constituting the initial |
| | capacitance “sea level” |
| e | Separated “peak” No. e |
| K | Default natural number (2K + 1 is the |
| | length of capacitance data |
| | selected or the width of the separated peak) |
| Ye1/Ye2 . . . | Y coordinate corresponding to the touch point |
| Xe1/Xe2 . . . | X coordinate corresponding to the touch point |

The technical proposal of this invention has the following advantages:

After the capacitance threshold value technology is adopted, the detection capacitance is provided with a threshold value, which reduces the volume of data to be processed, improves the anti-interference performance of the system to a certain extent and also lowers the possibility of wrong touch.

### Operation Embodiment

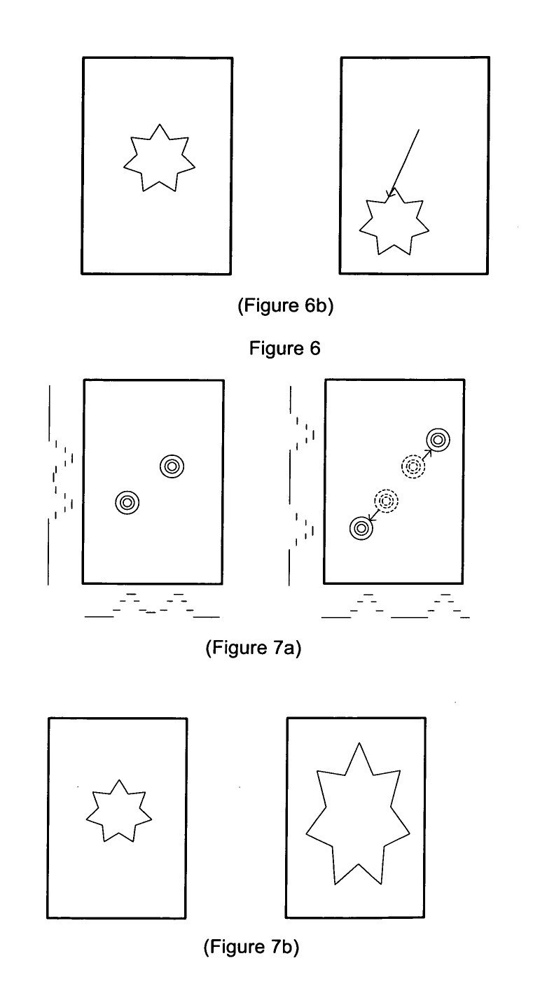

The self-capacitance multi-touch algorithm based on the capacitance threshold value can flexibly process various image operations, such as moving, zooming and rotating an image. Refer to FIGS. 6, 7 and 8 for specific schematic diagrams.

In FIGS. 6, 7 and 8, the solid line with an arrow is the movement trace of a finger or an image, the concentric circle indicates the finger before movement, and the dotted line concentric circle indicates the finger after movement.

FIG. 6 shows the movement of an image realized by a single-point touch. During the movement of the image, a single finger must touch the screen, i.e. drawing a line on the screen. The trace of such a line is the movement trace of the image, which enables a user to feel as if trailing the image.

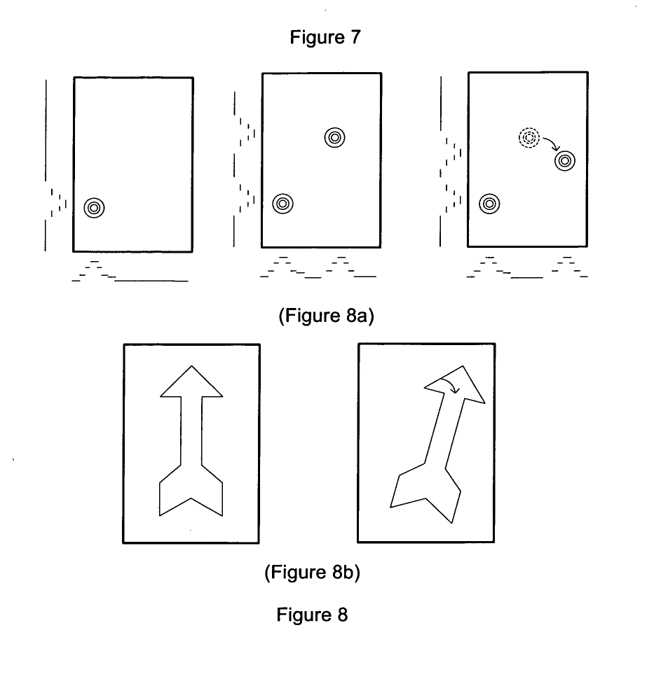

FIG. 7 shows the image zooming function realized by two-point touches. In order to finish this function, two fingers must also touch the screen, because the two fingers do not leave the screen, two touch points are given touch points. Two fingers can move simultaneously, or one finger does not move while the other finger moves. Zooming scale relation of an image is determined according to the scale relation between the distance before movement and the distance after movement. For the purpose of being different from the rotation of an image, the trace of finger movement is required to be in the same direction to the greatest extent.

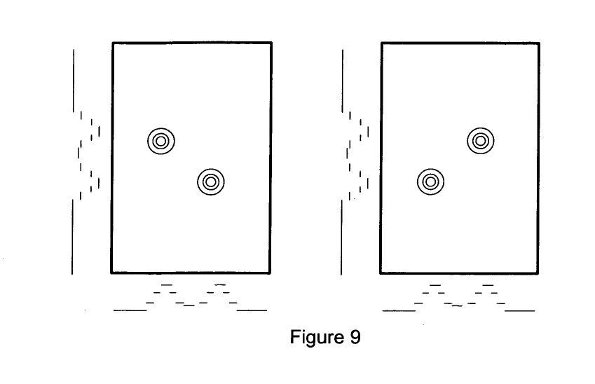

In FIG. 9, when “peaks” of the X axis and Y axis are detected (i.e. the finger is not in the same row or column on the capacitive screen), the processor will be unable to judge whether the finger is in the state as shown in the left figure in FIG. 9 or the state as shown in the right figure in FIG. 9, i.e. a “ghost” called by us. It can be seen from the left figure and the right figure in FIG. 9, the distances between touch points in such two figures are the same. In this way, if the image is only zoomed, i.e. the image is zoomed with the center of the screen as the symmetry point, the distance between two fingers before and after movement can be calculated to acquire image zooming scale. If the rotation direction of the image is required to be acquired, the method shown in FIG. 8 can be adopted.

FIG. 8 shows the rotation of an image by two-point touches. The implementation of such a function takes the action habits of human body into full consideration, thus being extremely easy to implement. The implementation process is as follows: firstly put a finger such as the thumb on the touch screen and then put another finger such as the forefinger on the screen. Keep the thumb fixed and rotate the forefinger clockwise or counterclockwise. The angle and direction of finger movement are the angle and direction of image movement. During the movement of the forefinger, the forefinger must also be put on the touch screen. During the rotation of the image, the thumb is a pivot point while the forefinger is a rotating point. In like manner, a user can also take the forefinger as the pivot point and the thumb as the rotating point, which completely depends on the habits of the user. In either manner, the software processing method is completely the same. With the adoption of the pivot point method, the problem that the rotation direction cannot be distinguished by the software due to a “ghost” can be solved.

During the rotation of an image, the displacement of the pivot point must be controlled within a certain range. For the purpose of distinguishing between zooming and rotation of an image, a critical angle value can be set. Take the critical angle value of 25° as an example, if the angle of rotation is smaller than 25°, the operation can be deemed as zooming of the image; if the angle of rotation is larger than 25°, the operation can be deemed as rotation of the image.

The following method can be adopted as well: in case that the pivot point of two given touch points does not move and the other touch point moves, if the moving direction of the moving touch point forms an included angle smaller than 45° with the connecting line between such two given touch points, it is judged to zoom an image; if the moving direction of the moving touch point forms an included angle larger than 45° with the connecting line between such two given touch points, it is judged to rotate an image.

What is claimed is:

1. A multi-touch detection method for capacitive touch screens, characterized in that the method includes the following steps:
101) conducting scan detection of capacitance of the rows and columns of a touch screen matrix to respectively acquire capacitance data of the rows and columns of the touch screen matrix;
102) acquiring an initial capacitance threshold value and calculating capacitance value of each row and each column by subtracting the initial capacitance threshold value from the capacitance data of each row and each column respectively;
103) judging whether a curved section with a capacitance value of more than zero exists in the calculated capacitance value curves of the rows and columns; if so, the gravity center point of each curved section with a calculated capacitance value of more than zero is taken as the contact point coordinate corresponding to the curved section; if not, no touch is made;
104) the column coordinate and the row coordinate of each contact point is sent to the processor for processing.

2. A multi-touch detection method for capacitive touch screens as specified in claim 1, characterized in that each row and each column of the touch screen matrix have a respective initial capacitance threshold value.

3. A multi-touch detection method for capacitive touch screens as specified in claim 2, characterized in that the capacitance threshold value of each row of the touch screen matrix is the sum of the scanning capacitance value of such row and the increment of row capacitance value, and the capacitance threshold value of each column is the sum of the scanning capacitance value of such column and the increment of column capacitance value, in which the scanning capacitance value is the capacitance value under circumstance where no touch is imposed on the rows or the columns of the touch screen matrix.

4. A multi-touch detection method for capacitive touch screens as specified in claim 3, characterized in that under the circumstance of having no touch, the capacitance threshold value is updated once the touch screen matrix scans a cycle.

5. A multi-touch detection method for capacitive touch screens as specified in claim 1, characterized in that, in Step 103, after the existence of the curved section with a capacitance value of more than zero in the calculated capacitance value curve of the rows and columns is judged, the highest point of each curved section with a capacitance value of more than zero is firstly sought through gradual increase of the capacitance threshold value, capacitance value curved sections on both sides of the highest point are retained according to a default width value, and then the gravity center point of each calculated capacitance value curved section is taken as the contact point coordinate corresponding to the curved section.

6. A multi-touch detection method for capacitive touch screens as specified in claim 5, characterized in that when the row coordinate and the column coordinate of two neighboring contact points are closer than the default coordinate threshold value, the coordinates of such two neighboring contact points are combined into the coordinates of the touch points as per the arithmetic mean.

7. A multi-touch detection method for capacitive touch screens as specified in claim 6, characterized in that under the circumstance of having only one touch point, the movement of such a touch point on a screen is judged to be the panning movements of an image.

8. A multi-touch detection method for capacitive touch screens as specified in claim 6, characterized in that when the straight-line distance between two given touch points changes, it is judged to zoom an image; and when one given touch point revolves around the other given touch point, it is judged to rotate an image.

9. A multi-touch detection method for capacitive touch screens as specified in claim 8, characterized in that, in case that two given touch points revolve relatively while the straight-line distance between such two given touch points changes, if the angle of rotation is smaller than the default value, it is judged to zoom an image; if the angle of rotation is larger than the default value, it is judged to rotate an image.

10. A multi-touch detection method for capacitive touch screens as specified in claim 8, characterized in that, in case that one of two given touch points does not move and the other point moves, if the moving direction of the moving touch point forms an included angle smaller than the default angle with the connecting line between such two given touch points, it is judged to zoom an image; if the moving direction of the moving touch point forms an included angle larger than the default value with the connecting line between such two given touch points, it is judged to rotate an image.
